(19) United States
(12) Patent Application Publication
(10) Pub. No.: US 2013/0183485 A1
(43) Pub. Date: Jul. 18, 2013

(54) ELASTIC MULTILAYER STRUCTURE HAVING ALVEOLI WITH HOLES

(71) Applicant: Jean Patrice Quenedey, Paris (FR)

(72) Inventor: Jean Patrice Quenedey, Paris (FR)

(73) Assignee: COLDPACK, Vitry sur Seine (FR)

(21) Appl. No.: 13/700,349

(22) PCT Filed: May 27, 2011
(86) PCT No.: PCT/FR11/51225

§ 371 Date: Mar. 26, 2013

(30) Foreign Application Priority Data
May 27, 2010 (FR) 1054074

(51) Int. Cl. B32B 3/26; B32B 3/28; B32B 7/04

(52) U.S. Cl. CPC B32B 3/266; B32B 7/045; B32B 3/28
USPC 428/137

(57) ABSTRACT

The invention provides a multilayer structure comprising: at least one first layer comprising a first film; and at least one springy second layer comprising a springy second film; the second layer being joined, in a plurality of junction zones, to the first layer; the junction zones defining a region of contact between the first layer and the second layer, the first layer and the second layer forming at least one cell outside the contact region. At least one cell presents at least one hole that is open to the outside.

The present invention relates to a multilayer structure comprising: at least one first layer comprising a first film; and at least one springy second layer comprising a springy second film and joined, in a plurality of junction zones, to the first layer, the junction zones defining a region of contact between the first layer and the second layer, the first layer and the second layer forming at least one cell outside the contact region.

Structures are known that are constituted by a plurality of layers, each layer being a springy film, e.g. a polymer film.

An example of such a structure is bubble wrap, constituted by two polymer films that are fastened together in certain zones in such a manner as to form closed cells.

Each cell thus holds captive a volume of air that acts as a cushion. The bubble wrap may thus be used as packaging for fragile goods that must be protected while they are being transported.

Such bubble wrap may also be used as thermal insulation, since the volumes of air held captive in the cells form thermal insulation.

A multilayer structure constituted by a stack of such bubble wrap that is fastened together in the thickness direction thus constitutes a thermal barrier having effectiveness that is multiplied, each layer of bubble wrap acting as an additional thermal barrier.

In certain configurations, it is desirable to be able to minimize the volume of such a multilayer structure so as to make it easier to transport it from its place of manufacture to the site in which the structure is to be used as thermal insulation.

However, a multilayer structure as described above cannot be transported easily since its volume is determined by the volume of the closed air-filled cells.

The present invention seeks to remedy those drawbacks.

The invention seeks to propose a multilayer structure having a volume that can be reduced with a view to transporting it, and that can be deployed by returning to its initial volume, while conserving good thermal insulation properties in its deployed state.

This object is achieved as a result of at least one cell of the multilayer structure presenting at least one hole that is open to the outside.

By means of such provisions, the structure may be flattened at each cell presenting a hole, since the air is able to leave the cell via the hole.

The volume of the structure can thus be reduced when force is exerted thereon, and, when that force is interrupted, the structure can then return to its initial shape by means of the elasticity of the materials that make up the layers.

Advantageously, the region of contact between the first layer and the second layer comprises a set of crossed continuous lines that form a grid, such that the portions of the first layer and of the second layer that are separated by the lines are a set of disjoint cells, each cell presenting at least one hole that is open to the outside.

For example, all of the space between the first layer and the second layer comprises a set of such disjoint cells.

All of the space between the first layer and the second layer thus constitutes thermal insulation, and the multilayer structure may be completely flattened by pressure, and may then return to its initial shape by means of the elasticity of the materials that make up the layers.

The invention can be well understood and its advantages appear better on reading the following detailed description of an embodiment shown by way of non-limiting example. The description refers to the accompanying drawing, in which:

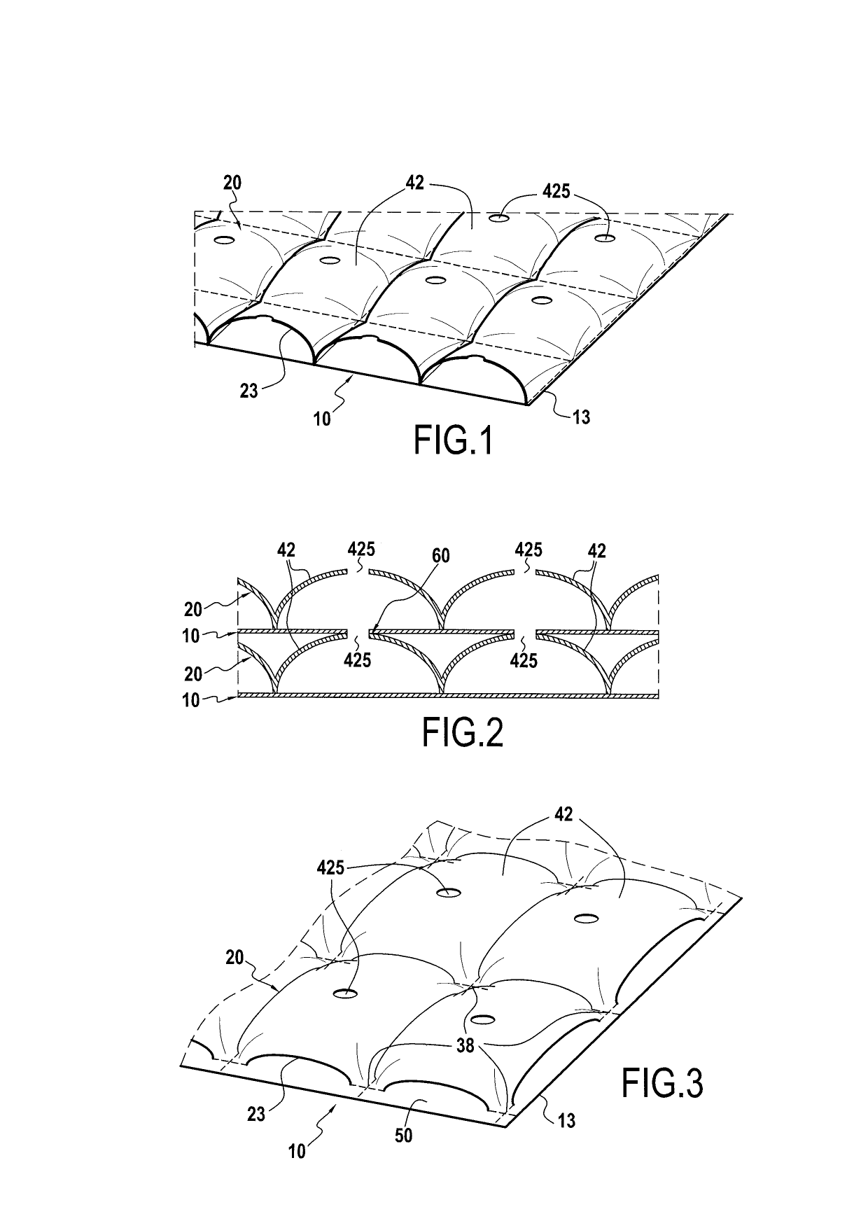

FIG. 1 is a perspective and section view of a multilayer structure of the invention;

FIG. 2 is a section view of another configuration of a multilayer structure of the invention; and

FIG. 3 is a perspective and section view of another configuration of a multilayer structure of the invention.

In the following description, the terms “inner” and “outer” respectively indicate, with reference to any two adjacent layers, the space between the two layers and the region outside the two layers.

Some of the layers (the “second” layer(s)) are springy, i.e. they are constituted by a deformable material that is capable of returning to its initial position after deformation.

In the following description, each layer is constituted by a polymer film. However, each or some of the layers may also be constituted by another material, e.g. metal.

For example, the other material may be a polymer material having shape memory, which material, if it is deformed (cells flattened, see above) below its glass-transition temperature, can return to its initial shape (cells deployed, see above) on being heated above its glass-transition temperature and while being free of stresses.

Each or some of the layers may also be constituted by a plurality of films of various materials.

FIG. 1 shows an example of a two-layer structure of the invention. The first layer 10 is constituted by a first polymer film 13.

The polymer film 13 of the first layer 10 may itself be constituted by a plurality of polymer films. For example, the polymer film 13 may be constituted by a film made of polyethylene (PE) sandwiched between two films made of Surlyn® (manufactured by Dupont de Nemours).

A second layer 20, constituted by a second polymer film 23, is fastened on the first layer 10 in known manner. For example, the second film 23 comprises Nucrel® (manufactured by Dupont de Nemours).

The second film 23 is fastened on the first film 13 in certain selected junction zones of the surface of the first film 13. These junction zones taken together are referred to as the contact region 30.

Outside the contact region 30, the first layer 10 and the second layer 20 cooperate to define a space 40 that has a shape that varies depending on the arrangement of the contact locations forming the contact region 30. Whatever the configuration, at least a portion of the space 40 is in the shape of a cell 42, i.e. in this portion, and at rest, the first layer 10 and the second layer 20 form a cell 42 occupying a certain volume, as shown in FIG. 1. A layer is at rest when it is not stressed.

For example, the contact region 30 is configured in such a manner that the second layer 20 is quilted when the first layer 10 is plane.

In FIG. 1, the region 30 of contact between the first layer 10 and the second layer 20 comprises a set of crossed continuous lines 38 that form a grid, such that some or all of the first layer 10 and of the second layer 20 form(s) a set of disjoint cells 42 that are separated by the lines, the cells 42 thus forming a checkerboard, each cell 42 presenting at least one hole 425 that is open to the outside.

The continuous lines 38 may be curved or rectilinear.

For example, the first half of the lines 38 are parallel to one another, the other half of the lines 38 being parallel to one another and perpendicular to the lines 38 of the first half, such that the cells 42 that are separated by the lines 38 form a rectangular checkerboard, as shown in FIG. 1.

Each of the cells 42 presents a hole 425.

The hole may pass through the first layer 10 or through the second layer 20.

Advantageously, the cell shape maximizes the springy properties of the second layer 20. For example, the cells may be cylindrical in shape, having a base that is circular or hexagonal.

The multilayer structure 1 of the invention may also be built up by superposing any number of assemblies, each formed of a first layer 10 and/or of a second layer 20, as described above. The second layer 20 is thus in contact with the first layer 10 of the adjacent assembly via an inter-assembly contact region 60, as shown in FIG. 2.

In this configuration, it is advantageous for the contact region 30 of one assembly and the region 60 of inter-assembly contact with the adjacent assembly not to be superposed, so as to minimize thermal bridges.

When each of the cells 42 presents one or more holes 425 passing through the second layers 20, the first layers 10 are also provided with holes so as to enable the air to escape from the space between the second layer 20 of one assembly and the first layer 10 of the adjacent assembly.

Advantageously, the holes are offset between two adjacent assemblies, so as to optimize the thermal insulation provided by the multilayer structure 1. I.e. the holes 425 of a second layer 20 of a lower assembly open out into the space between that second layer 20 and the first layer 10 of the upper assembly that is situated above the lower assembly and that is fastened on said second layer 20. The air leaving these holes 425 thus communicates with the outside via holes in the first layer 10 of the upper assembly, which holes themselves communicate with holes 425 in the second layer 20 of the upper assembly, and so on until the uppermost layer of the structure 1, also provided with holes.

Alternatively, the space between the second layer 20 of a first assembly and the first layer 10 of the second assembly that is situated above may be open to and in communication with the outside via the side edges of the structure 1, thereby making it possible to evacuate the air from the space.

In a certain configuration, each first layer 10 of an upper assembly is fastened on the tops of the cells 42 of the second layer 20 of a lower assembly, and the holes 425 that are situated in said tops, also pass through the first layer 10 of the upper assembly. The holes 425 open out into the cells 42 of the upper assembly, which cells have tops that are perforated with holes 425 that pass through the first layer 10 of the next upper assembly that is fastened on said upper assembly via the tops of the cells 42, and so on. This configuration is shown in FIG. 2.

Thus, for each hole passing through a lower assembly, there exists a series of holes situated on the same axis through the thickness of the structure, each hole passing through an assembly of the structure 1. In this way, a multilayer structure 1 may be perforated quickly, in a single operation, by being placed in a perforator that perforates the structure through its entire thickness (except possibly the lowermost first layer of the assembly).

In the above-described configurations, the multilayer structure 1 may be flattened so as to form a thin sheet, since the air can thus leave the cells 42 via the holes 425. The total volume of a multilayer structure 1 containing one or more assemblies formed of such first and second layers 10 and 20 may thus be considerably reduced while it is being transported. It should be observed that in this configuration it is not necessary for the first layers 10 to be as springy as the second layers, if at all. They may be very rigid (deformation less than 1%).

For example, when all of the layers are substantially equally springy, the multilayer structure 1, once flattened, may be rolled up so as to form a roll, for example.

Once on site, the multilayer structure 1 may be relieved of stresses and placed at rest, so as to return to its initial deployed configuration. This initial configuration is achieved by means of the springiness of the second films that form the structure, which springiness tends to cause the cells 42 to return to their initial convex shape.

Once deployed, the multilayer structure 1 thus offers good thermal insulation.

For example, such a structure 1 may be cut to the appropriate size, then placed in the spaces between the rafters below the roof of a dwelling so as to improve the thermal insulation of the dwelling.

If the structure 1 is suspended by its top face, the weight of the layers situated below the top face contributes, under the effect of gravity, to causing the structure 1 to return to its initial deployed configuration. Gravity thus acts in addition to the springiness of the layers of the structure 1.

The holes 425 may be situated at the tops of the cells 42, passing through the second layer 20.

Advantageously, the diameter of the holes 425 is less than 1/10 (one tenth) of the maximum dimension of the cells 42. Thus, in the deployed position, the flow of air entering and leaving the cells is minimized, thereby improving the thermal insulation properties of the structure 1.

Each cell 42 may present a plurality of holes 425 that are distributed over the first layer 10 and/or over the second layer 20.

In another configuration, the contact region 30 comprises a set of disjoint zones 38, such that the portions of the first layer 10 and of the second layer 20 that surround the zones 38 form a set of cells 42 that communicate with one another.

For example, all of the contact region 30 may be formed of such zones 38, as shown in FIG. 3.

In this configuration, it suffices for one or only some of the cells 42 to be provided with a hole 425 that communicates with the outside. By way of example, the hole(s) 425 may be situated in the cells 42 on the side edges of the structure. For structures formed of more than two layers, the holes 425 may alternatively communicate with other holes on other layers, which holes themselves finally communicate with the outside.

Such a multilayer structure 1 containing one or more assemblies formed of such first and second layers 10 and 20, may be flattened for being transported, then deployed as explained above.

Advantageously, the first film 13 is a polymer film that carries, on a first face, a metal deposit, the first face being a free face of said first layer 10, the second layer 20 being joined to the first layer 10 on the first face that carries the metal deposit.

For example, the first layer 10 is constituted by a first polymer film 13 that carries a metal deposit 50 on one of its faces, referred to as its “first” face. The polymer film 13 of the first layer 10 may itself be constituted by a plurality of polymer films. For example, the polymer film 13 may be constituted by a film made of polyethylene (PE) sandwiched between two films made of Surlyn® (manufactured by Dupont de Nemours).

The second layer 20, constituted by a second polymer film 23, is fastened on the first face that carries the metal deposit 50. Said fastening is performed in known manner, e.g. using a second film 23 comprising Nucrel® (manufactured by Dupont de Nemours).

Given that the first face of the first film 10 carrying the metal deposit 50 is in contact with the volume of air present in the cells 42 between the first layer 10 and the second layer 20, or, in equivalent manner, between the first film 10 and the second film 20, and given that the metallized face constitutes the face of the first film 20 having the lowest emissivity, heat flow through the cells 42 is minimized. This results in a multilayer structure 1 comprising an assembly formed of the first layer 10 and of the second layer 20 presenting thermal insulation that is better than that of a multilayer structure not having any films with a metallized face.

In all of the above-mentioned embodiments, it is advantageous for the contact region 30 formed by the set of contact locations joining together the first and second layers 10 and 20 to be of an area that is very small compared to the total area of the surface of the first film 10 facing the second film 20. The contact locations act as thermal bridges through the multilayer structure. A structure in which thermal bridges are minimized is thus more thermally insulating.

In an assembly made up of a first layer 10 and of a second layer 20 as described above, the contact region 30 may be formed of a combination of contact lines 38 and/or of contact zones 38, as described above.

In the invention, some or all of a multilayer structure 1 may be formed of any combination of such assemblies.

In addition to a first and second layer, each assembly may contain additional optionally-springy layers.

From one assembly to another, the first layers and/or the second layers (and/or any additional layers) may be similar or different.

The multilayer structure 1 of the invention may also include superposing any number of assemblies, with each assembly being formed of a first layer 10 and/or of a second layer 20, as described above, and of third layers that are interposed between one or more of said assemblies. By way of example, a third layer comprises a third polymer film.

Advantageously, the third layer is joined, in a plurality of junction zones, to the second layer 20 of a first assembly, the junction zones defining a contact region having a surface area that is smaller than the surface area of the second layer 20, and the third layer is also joined, in a plurality of junction zones, to the first layer 10 of another assembly, the junction zones defining a contact region having a surface area that is smaller than the surface area of the first layer 10. The third layer thus makes it easier to assemble together two adjacent assemblies. By way of example, the contact regions are a combination of lines 38 and/or of zones 38, as described above.

At least a fraction of the holes 425 may pass through the third layer.

In this configuration, it is advantageous for the holes 425 to be offset between two adjacent assemblies, so as to optimize the thermal insulation provided by the multilayer structure 1. I.e. the holes 425 of a third layer open out into the space between the third layer and the first layer 10 of the upper assembly that is situated above the third layer and that is fastened on the third layer. The air leaving these holes 425 thus communicates with the outside via holes in the first layer 10 of the upper assembly, which holes themselves communicate with holes 425 in the second layer 20 and third layer of said upper assembly, and so on until the uppermost layer of the structure 1, also provided with holes.

Alternatively, the space immediately below or above a third layer may be open and in communication with the outside via the side edges of the structure 1, thereby making it possible to evacuate the air from said space.

1. A multilayer structure comprising: at least one first layer comprising a first film; and at least one springy second layer comprising a springy second film; said second layer being joined, in a plurality of junction zones, to said first layer; the junction zones defining a region of contact between said first layer and said second layer, said first layer and said second layer forming at least one cell outside the contact region; wherein said at least one cell presents at least one hole that is open to the outside.

2. A multilayer structure according to claim 1, wherein said contact region comprises a set of crossed continuous lines that form a grid, such that the portions of said first layer and of said second layer that are separated by the lines form a set of disjoint cells, each cell presenting at least one hole that is open to the outside.

3. A multilayer structure according to claim 1, wherein said contact region comprises a set of disjoint zones, such that the portions of said first layer and of said second layer that surround the zones are a set of cells that communicate with one another.

4. A multilayer structure according to claim 1, wherein at least a fraction of said holes pass through said first layer.

5. A multilayer structure according to claim 1, wherein at least a fraction of said holes pass through said second layer.

6. A multilayer structure according to claim 1, wherein said first layer is springy.

7. A multilayer structure according to claim 1, wherein said first film is a polymer film that carries, on a first face, a metal deposit, the first face being a free face of said first layer, said second layer being joined to said first layer on said first face that carries said metal deposit.

8. A multilayer structure according to claim 1, wherein it further comprises a third layer comprising a third polymer film that is joined in a plurality of junction zones to the second layer, each junction zone defining a contact region having a surface area that is smaller than the surface area of said second layer.

9. A multilayer structure according to claim 8, wherein at least a fraction of said holes pass through said third layer.
